(19) United States
(12) Patent Application Publication
(10) Pub. No.: US 2020/0094638 A1
(43) Pub. Date: Mar. 26, 2020

(54) STABILITY CONTROL FOR OPERATION OF A CONVERTIBLE AIR-ROAD VEHICLE

(71) Applicant: AEROMOBIL R&D, S.R.O., Bratislava (SK)

(72) Inventors: Doug MACANDREW, Bystrica (SK); Simon ROOMS, Bratislava (SK); Alan ROACH, Oslo (NO); lan CLARK, Faringdon (GB); Steve RANDLE, Warwick (GB)

(73) Assignee: AEROMOBIL R&D, S.R.O., Bratislava (SK)

(21) Appl. No.: 16/469,440

(22) PCT Filed: Dec. 12, 2017
(86) PCT No.: PCT/EP2017/082484

§ 371 Date: Jun. 13, 2019

(30) Foreign Application Priority Data
Dec. 13, 2016 (EP) 16203808.7

(51) Int. Cl. B60F 5/02; B62D 1/04; B60K 1/02; B64C 37/00; B64C 13/04; B64C 25/44; B64C 3/56

(52) U.S. Cl. CPC B60F 5/02; B62D 1/04; B60K 1/02; B64C 3/56; B64C 13/0421; B64C 25/44; B64C 37/00

(57) ABSTRACT

A vehicle having a first configuration for road use and a second configuration for air use, comprises road wheels; a first steering control input, such as a steering wheel, for directional control of road wheels when in contact with the ground; a traction drive propulsion unit for driving road wheels when in contact with the ground, for example an electric motor connected to each driven wheel; a traction drive power control input, such as a throttle pedal; a second steering control input, such as rudder pedals, for operation of control surfaces for the aerodynamic directional control of the vehicle; an aerodynamic thrust propulsion unit for driving the vehicle through the air, such as a motor connected to a propeller mounted on the vehicle; and a thrust power control input, such as a throttle lever; and optionally a road wheel brake control input, such as a brake pedal; wherein, when the vehicle is in the second configuration and the wheels are in contact with the ground, the thrust power control input is operable to control power to the aerodynamic thrust propulsion unit and to the traction drive propulsion unit to accelerate the vehicle; and both the first steering control input and the second steering control input are operable to control the direction of travel of the vehicle.

### FIELD OF THE INVENTION

This invention relates to control systems suitable for use on a vehicle configurable for air or road use. Such vehicles are commonly known as flying cars or roadable aircraft (hereafter “flying cars”). In particular, the invention relates to operational control of such a vehicle.

### BACKGROUND

There have been a number of previous proposals for flying car designs, i.e. vehicles that can be fully compliant with legal and practical requirements for both road and flight use. Examples include the Terrafugia Transition (WO 2007/114877), the Carplane (http://carplane.de/), the AeroMobil (WO 2013/03240, WO 2016/057003, WO 2016/057004), and the Moller Skycar (http://moller.com/).

One particular issue faced by flying cars is that the standard control inputs for driving and flying are significantly different. For driving, hand control input is used for steering, and foot control for throttle and brake. For flying, hand control is used for pitch (elevator) and roll (aileron), typically using a stick or yoke, and throttle, and foot control for yaw (rudder), and often for differential wheel braking. It is therefore not possible to provide a single set of control inputs that satisfy regulatory requirements for both air and road uses. In addition, the possibility of operator error becomes high if the same input have different uses depending on mode of use.

WO 2016/057003 discloses one proposal for easily shifting between hand control inputs for air and road use.

Other proposals, such as the Terrafugia Transition, provides a complete set of each inputs: both a steering wheel for road use and stick and hand throttle for air use, and two pairs of pedals, an inner pair for road use (throttle and brake), and an outer pair for rudder (yaw) control.

One particular problem encountered by aircraft is that directional control and stability on the ground can be difficult due to the low airspeed over control surfaces. Similarly, differential braking of wheels is only effective where the aircraft is taxiing at some speed. Road vehicles usually have better low speed directional control and braking. However, where there are separate road and flight controls, simultaneous operation is often difficult to achieve safely.

This invention attempts to address at least some of these problems.

### SUMMARY

A first aspect of the invention provides a vehicle having a first configuration for road use (“road use configuration”) and a second configuration for air use (“flight configuration”), comprising:

road wheels;

a first steering control input, such as a steering wheel, for directional control of road wheels when in contact with the ground;

a traction drive propulsion unit for driving road wheels when in contact with the ground, for example an electric motor connected to each driven wheel;

a traction drive power control input, such as a throttle pedal;

a second steering control input , such as rudder pedals, for operation of control surfaces for the aerodynamic directional control of the vehicle;

an aerodynamic thrust propulsion unit for driving the vehicle through the air, such as a motor connected to a propeller mounted on the vehicle; and

a thrust power control input, such as a throttle lever; and optionally

a road wheel brake control input, such as a brake pedal;

wherein, when the vehicle is in the second configuration and the wheels are in contact with the ground, the thrust power control input is operable to control power to the aerodynamic thrust propulsion unit and to the traction drive propulsion unit to accelerate the vehicle; and both the first steering control input and the second steering control input are operable to control the direction of travel of the vehicle.

The road wheels under the control of the first steering input can be at the front of the vehicle and can also be driven by the traction drive unit.

A throttle lever can be configured such that movement to a first side of a idle position acts to vary the power to the thrust propulsion unit, and operation to a second side of the idle position acts to vary braking effort applied to the road wheels. In one example, when the lever is operated on the first side of the idle position, the second steering control input is configured to apply steering control to the road wheels by vectoring torque to the drive road wheels.

In some embodiments, the thrust power control input can be configured to variably control power to the traction drive propulsion unit according to the airspeed of the vehicle.

In some embodiments, the first steering control input can be configured to be operable only when the road wheels are in contact with the ground.

In some embodiments, the road wheels are moveable between a first, extended position for use when the vehicle is in the first configuration, or is in the second configuration and the road wheels are in contact with the ground; and a second, retracted position for use when the vehicle is in the second configuration and in flight.

Another aspect of the invention provides a method of operating a vehicle according to the first aspect, comprising:

placing the vehicle in the second configuration with the road wheels in contact with the ground;

in one mode of operation, using the thrust power control input to control power from both the thrust propulsion unit and the traction drive propulsion unit to control the speed of the vehicle on the ground while controlling direction of travel on the ground using the first steering control input; and

in another mode of operation, using the thrust power control input to control power from the thrust propulsion unit to control the airspeed of the vehicle while controlling direction of travel using the second steering control input.

A still further aspect of the invention provides a method of operating a vehicle according to the first aspect comprising:

placing the vehicle in the second configuration wherein the road wheels are initially not in contact with the ground;

in one mode of operation, using the thrust power control input to control power from the thrust propulsion unit to control the airspeed of the vehicle while controlling direction of travel using the second steering control input so as to bring the road wheels into contact with the ground; and

in another mode of operation wherein the road wheels are in contact with the ground, using the thrust power control input to control power from both the thrust propulsion unit and the traction drive propulsion unit to control the speed of the vehicle on the ground while controlling direction of travel on the ground using the first steering control input.

Both methods can further comprise using the thrust power control input to apply a braking force to the road wheels when the road wheels are in contact with the ground; and/or using the second steering control input to the road wheels.

The vehicle can comprise a body, wings connected to the body and moveable between a folded position for the first configuration and an extended position for the second configuration, a tail section at the rear of the body, and moveable control surfaces for controlling operation of the vehicle in the air.

Further variations can be made within the scope of the invention.

### DRAWINGS

FIG. 1 shows a perspective view of a flying car in a flight configuration;

FIG. 2 shoes a front perspective view of a flying car in a road use configuration; and

FIGS. 3 and 4 shows schematic views of the control layout of the flying car of FIGS. 1 and 2 when configured for road use and for flight.

### DETAILED DESCRIPTION

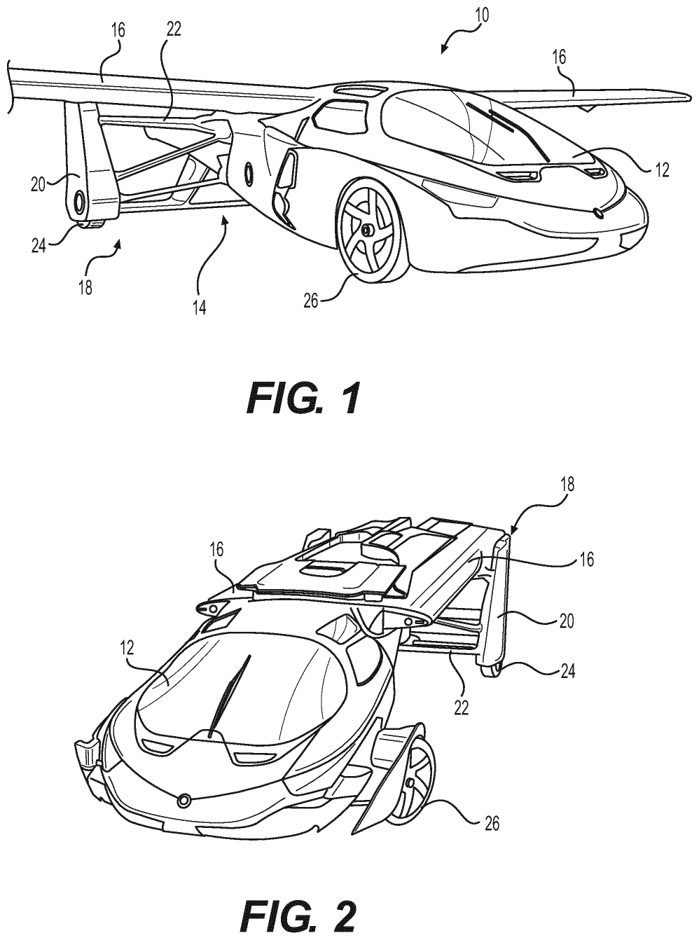

Referring to FIGS. 1 and 2, an aircraft comprising a convertible vehicle (a flying car) is shown, in a flight configuration (FIG. 1) and a road use configuration (FIG. 2). The flying car comprises a body structure 10 providing a crew compartment 12 and housing a main motor (not shown) and propeller shaft (not shown) that extends from the main motor to the rear 14 of the body structure 10, where the propeller is mounted as is described below. Wings 16 for providing lift and control (via ailerons, not shown) are mounted at the top of the body 10 immediately behind the crew compartment 12. The wings 16 can be moved between an extended position for flight use (FIG. 1), and a folded position for road use (FIG. 2). In the folded position, the wings lie along the top of the body 10, the long axis of the wings lying substantially parallel to the long axis of the body 10. The folding mechanism is substantially as described in WO 2013/03240.

A tail structure 18 is located at the rear of the body 10, and includes vertical control surfaces 20 (fins and rudders), and horizontal control surfaces 22 (tail planes and elevators). Rear wheels 24 are provided at the lower ends of the fins 20.

Front wheels 26 are mounted on the body structure 10. The front wheels are both steerable and driven. In addition, the front wheels 26 can be moved between a retracted position (FIG. 1) in which they are positioned close to the body to reduce drag in flight, and an open position (FIG. 2) in which they are positioned for improved traction and control for road use. Drive is provided to the front wheels by means of electric motors (not shown) that are provided with power from the motor. There is one electric motor for each front wheel 26. The electric motors can be driven together, or can be controlled to provide different or vectors drive to each wheel, assisting in stability and steering.

In flight use, the main motor is used to drive the propeller and provide thrust.

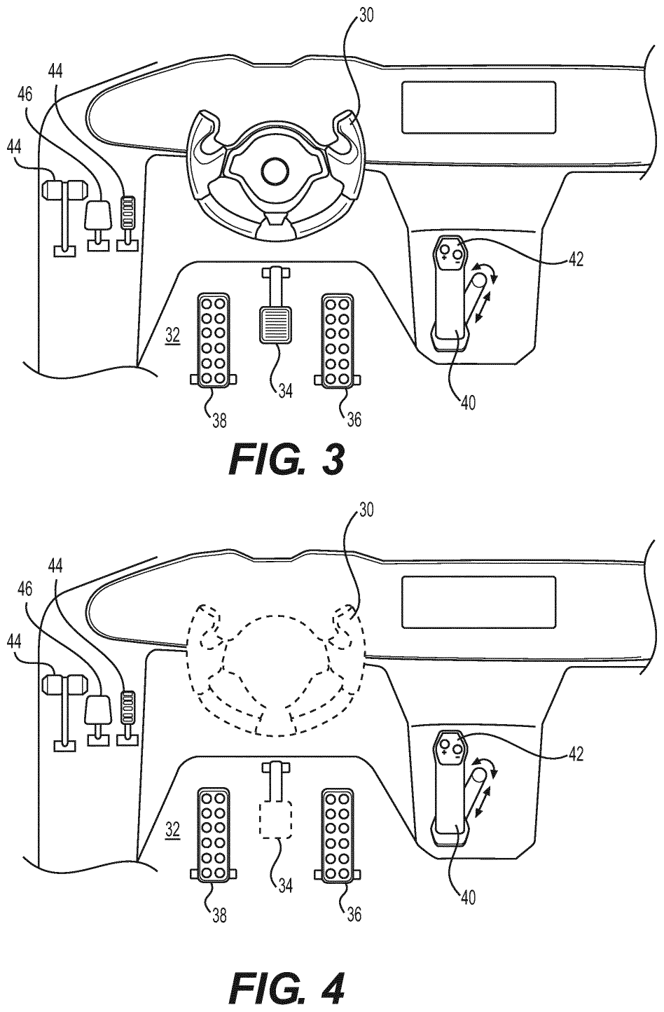

FIG. 3 shows a partial view inside the crew compartment 12 when the vehicle is configured for road use. A steering wheel 30 is positioned in a conventional configuration ahead of a driver/pilot seat (not shown). In road use configuration (FIG. 2), the steering wheel 30 operates the front wheels 26 in a conventional manner.

A three pedal arrangement is provided in a foot well 32 below the steering wheel 30. The pedals comprise a central brake pedal 34, and first and second side pedals 36, 38. The brake 34 acts on both the front and rear wheels 24, 26. In a first configuration for road use (FIG. 2), the first side pedal 36 is configured as a throttle pedal and operates in the conventional foot-controlled manner to apply power to the driven front wheels 26. For example, as the front wheels are driven by electric motors, the throttle pedal 36 acts to control the current provided to the motors. In this configuration, the second side pedal 38 is fixed in position and acts as a foot rest.

FIG. 4 shows the corresponding view to FIG. 3 when in a second configuration for flight use (FIG. 1). In this case the pedals are reconfigured so that the throttle function of the first side pedal 36 is disconnected, and the second side pedal 38 is released from its fixed position. The two side pedals 36, 38 are connected to yaw control surfaces (rudders) on the tail 20, and arranged to operate so that depressing the first (right) side pedal 36 will cause the vehicle to yaw right, and depressing the second (left) side pedal 38 will cause the vehicle to yaw left. The brake pedal 34 can remain active for use on the wheels 24, 26 when taxiing while the vehicle is still in flight configuration.

To the right of the steering wheel 30 is a side stick control column 40 which is connected to roll and pitch control surfaces (ailerons and elevators) on the wings 16 and tail 22 for use in flight configuration (FIG. 1). Pitch trim control buttons 42 are provided on top of the side stick 40. In road use, the side stick 40 is inactive.

Levers for throttle 44, flap setting 46, and landing gear deployment 48 are located to the left of the steering wheel. In normal road use configuration (FIG. 2), these are inactive. In air use configuration (FIG. 1), these levers operate in a conventional manner on engine flap and landing gear mechanisms.

In take-off and landing situations, it is possible to use aspects of one or other control configuration to assist in maintaining stability of the vehicle as it transitions between air and ground use. For example, it is possible to use aspects of road use control when the vehicle is on the ground and aerodynamic control is less effective due to low airspeed over control surfaces. It is also possible to utilize certain aspects of control inputs from one mode in another as will be described in more details below.

For example, when the vehicle is configured for flight use but is still on the ground, the control inputs are configured such that the pedals 36, 38 are configured as rudder pedals and the steering wheel 30 is still operable to steer the front wheels 26. In addition, the throttle lever 44 is configured to operate both the main motor to drive the propeller and the electric motors driving the from wheels 26. Therefore, at an early stage, when airspeed over the rudders is still too low to be immediately effective, the steering wheel can be used to ensure that the vehicle remains pointed in the correct direction as the speed begins to build, in addition to any rudder input from the pedals 36, 38. Once the airspeed is sufficient for effective aerodynamic control, as may be indicated by the “feel” of the controls, by indicator lights, buzzers, etc., the operator can release the steering wheel and assume normal flight control using only the side stick 40 and rudder pedals 36, 38. Power control to the front wheels 26 can be made inactive by use of a speed sensor, or by a load detectors indicating that the wheels are no longer in contact with the ground. In addition, power application at the wheels can be made speed dependent so that for a given throttle setting, the power to the wheels reduces as the speed increases.

Once the vehicle is airborne, the operator can retract the wheels by operation of level 48, at which time the possibility of steering or power inputs to the wheels can be disabled completely.

The brake pedal 34 can remain active at all times. In addition to operation of physical braking systems, operation of the foot brake can also be effective to disable electric drive to the front wheels 26.

When landing, the wheels can be lowered by operation of the lever 48. Operation on approach is in the conventional manner. However, once the wheels are in contact with the ground, a combined mode operation again becomes possible. The throttle lever 44 is provided with a detent towards the rear of its travel, the detent defining the normal idle position. In flight use, operation of the throttle is ahead of the detent/idle position, the throttle being pushed forward to increase power and pulled back to decrease power. With the vehicle on the ground, pulling the throttle lever back past the detent leaves the motor at idle setting, but progressively applies braking to the road wheels. This is in addition to any braking applied using the brake pedal 34. Thus the operator can retain full control of attitude using the side stick 40 and rudder pedals 36, 38 while having additional braking available.

In the reverse of the takeoff procedure, the steering wheel can become active once landing is detected and the speed is at a level where aerodynamic steering becomes more difficult. At such speeds, the wings will be providing little lift and other control surfaces become less effective, meaning that the side stick 40 can ultimately be left unattended without loss of vehicle control. In addition, full control can be maintained with two-handed operation.

In a variant of these operations, the rudder pedals 36, 38 can also be used to control the wheel motors to provide torque vectoring at the wheel electric motors and so aid directional control while on the ground. The steering angle provided by such vectoring can be under speed sensor control. Torque vectoring can be disabled completely where the speed sensor indicates that full aerodynamic control is possible. Torque vectoring would also be disabled when braking is applied via the throttle lever 44 in the manner described above. Torque vectoring is an additional feature to other commonly used safety systems, e.g. ABS (Anti-Lock Braking System), EBC (Emergency Brake Control), etc.

Changes can be made while remaining within the scope of the invention.

Control surfaces can be operated using cable and/or rod linkages. Propeller pitch control can be manual or automatic. Gear section for road use is automatic or CVT. Road throttle control can be electrical/electronic, and braking can be mechanical/hydraulic as is conventional for road vehicles.

1. A vehicle having a first configuration for road use and a second configuration for air use, comprising:
road wheels;
a first steering control input for directional control of road wheels when in contact with the ground;
a traction drive propulsion unit for driving road wheels when in contact with the ground;
a traction drive power control input;
a second steering control input for operation of control surfaces for the aerodynamic directional control of the vehicle; and
an aerodynamic thrust propulsion unit for driving the vehicle through the air; and
a thrust power control input;
wherein, when the vehicle is in the second configuration and the wheels are in contact with the ground, the thrust power control input is operable to control power to the aerodynamic thrust propulsion unit and to the traction drive propulsion unit to accelerate the vehicle; and both the first steering control input and the second steering control input are operable to control the direction of travel of the vehicle.

2. The vehicle as claimed in claim 1, wherein the road wheels under the control of the first steering input are at the front of the vehicle and are also driven by the traction drive propulsion unit.

3. The vehicle as claimed in claim 1, wherein the traction drive propulsion unit comprises an electric motor connected to each driven wheel.

4. The vehicle as claimed in claim 1, wherein the first steering control input comprises a steering wheel.

5. The vehicle as claimed in claim 1, wherein at least one of the traction drive power input, or the second steering control input comprises one or more pedals.

6. The vehicle as claimed in claim 1, wherein the thrust power control input comprises a hand-operated throttle lever.

7. The vehicle as claimed in claim 6, wherein the throttle lever is configured such that movement to a first side of a idle position acts to vary the power to the thrust propulsion unit, and operation to a second side of the idle position acts to vary braking effort applied to the road wheels.

8. The vehicle as claimed in claim 7, wherein when the lever is operated on the first side of the idle position, the second steering control input is configured to apply steering control to the road wheels by vectoring torque to the drive road wheels.

9. The vehicle as claimed in claim 1, wherein the thrust power control input is configured to variably control power to the traction drive propulsion unit according to the airspeed of the vehicle.

10. The vehicle as claimed in claim 1, wherein the first steering control input is configured to be operable only when the road wheels are in contact with the ground.

11. The vehicle as claimed in claim 1, wherein the road wheels are moveable between a first, extended position for use when the vehicle is in the first configuration, or is in the second configuration and the road wheels are in contact with the ground; and a second, retracted position for use when the vehicle is in the second configuration and in flight.

12. The vehicle as claimed in claim 1, further comprising a road wheel brake control input.

13. A method of operating the vehicle as claimed claim 1, the method comprising:
placing the vehicle in the second configuration with the road wheels in contact with the ground;
in one mode of operation, using the thrust power control input to control power from both the thrust propulsion unit and the traction drive propulsion unit to control the speed of the vehicle on the ground while controlling direction of travel on the ground using the first steering control input; and
in another mode of operation, using the thrust power control input to control power from the thrust propulsion unit to control the airspeed of the vehicle while controlling direction of travel using the second steering control input.

14. A method of operating the vehicle as claimed in claim 1, the method comprising:
placing the vehicle in the second configuration wherein the road wheels are initially not in contact with the ground;
in one mode of operation, using the thrust power control input to control power from the thrust propulsion unit to control the airspeed of the vehicle while controlling direction of travel using the second steering control input so as to bring the road wheels into contact with the ground; and
in another mode of operation wherein the road wheels are in contact with the ground, using the thrust power control input to control power from both the thrust propulsion unit and the traction drive propulsion unit to control the speed of the vehicle on the ground while controlling direction of travel on the ground using the first steering control input.

15. The method as claimed in claim 13, further comprising using the thrust power control input to apply a braking force to the road wheels when the road wheels are in contact with the ground; and/or using the second steering control input to the road wheels.

16. The method as claimed in claim 14, further comprising using the thrust power control input to apply a braking force to the road wheels when the road wheels are in contact with the ground; and/or using the second steering control input to the road wheels.
